(19) United States
(12) Patent Application Publication
(10) Pub. No.: US 2008/0232682 A1
(43) Pub. Date: Sep. 25, 2008

(54) SYSTEM AND METHOD FOR IDENTIFYING PATTERNS

(76) Inventor: Kumar Eswaran, Secunberabad (IN)

Correspondence Address: OCCHIUTI ROHLICEK & TSAO, LLP, 10 FAWCETT STREET, CAMBRIDGE, MA, 02138, US

(21) Appl. No.: 12/048,848

(22) Filed: Mar. 14, 2008

(30) Foreign Application Priority Data
Mar. 19, 2007 (IN) 554/CHE/2007

(51) Int. Cl. G06K 9/62; G06K 9/72

(52) U.S. Cl. 382/159; 382/224

(57) ABSTRACT

The present invention provides a system and method for identifying a pattern as belonging to one of a set of predetermined classes of patterns. The system comprises a plurality of classifier blocks wherein each classifier block corresponds to a distinct predetermined class of patterns and produces a mirror image of an input pattern if the input pattern belongs to the predetermined class. The system also comprises a plurality of sub-classifier blocks wherein each sub-classifier block corresponds to a distinct predetermined sub-class of a predetermined class of patterns and is coupled to a classifier block corresponding thereto for producing a mirror image of an input pattern if the pattern belongs to the predetermined sub-class. The system further comprises an input unit for capturing the pattern for identification and an output unit for displaying at least one of a mirror image of an input pattern and an identified class and sub-class of the input pattern. The system and method of the present invention may also be used as sub-modules for building large generalized learning systems.

### CROSS-REFERENCE TO RELATED APPLICATIONS

This application claims the benefit of Indian Application Serial No. 554/CHE/2007 filed on Mar. 19, 2007. The contents of which is hereby incorporated by reference in its entirety.

### FIELD OF INVENTION

The present invention is directed towards identification of patterns. More particularly, the present invention provides a system and method for identifying a pattern by using a mirroring network trained to output a mirror image of an input pattern if the input pattern belongs to a predefined class.

### BACKGROUND OF THE INVENTION

Pattern identification involves classifying observed or measured data into known categories using statistical or syntactic approaches. Applications of pattern recognition include biometrics such as fingerprint, iris, and facial image identification, weather forecasting by map analysis, character recognition, speech recognition, medical diagnostic data analysis, and bar code recognition.

Conventionally in a pattern identification system firstly an object being identified is represented as data that may be further processed. For example, for facial identification a facial image is captured as a photograph, and for speech recognition spoken words to be identified are input through a microphone. Next, feature extraction is carried out on the data in order to extract essential features that may be used for comparison of the object being identified with similar objects. For example, in case of identification of a facial image from a photograph, pixels of the photograph are used as features for comparison. Since, even a low quality photograph comprises a huge number of pixels, extensive computing power and a large memory is required for identifying the image. There is need for a system and method for reducing dimensions of an unidentified pattern, while maintaining all essential features of the pattern, in order to enable pattern identification using reduced computing power and memory requirements.

Various pattern identification schemes known in the art employ artificial neural networks (ANN) for pattern identification and clustering. Prior to automatically identifying input patterns, neural networks have to be trained to do so. During training the ANN is trained to associate output patterns with input patterns, so that when the ANN is used it identifies input patterns and tries to output the associated output pattern. When a pattern that has no output pattern associated with it is given as input to the ANN, the network produces an output pattern corresponding to a taught input pattern that is least different from the given input pattern. In this manner, an ANN can be taught to identify patterns via supervised or unsupervised learning methodologies. Since supervised learning methods require human intervention, they are considered less efficient and are prone to human errors. There is a need for efficient unsupervised learning methods for training ANN for use in applications involving pattern identification and clustering.

### SUMMARY OF THE INVENTION

A system for identifying a pattern as belonging to one of a set of predetermined classes of patterns is provided. The system comprises a plurality of classifier blocks, each classifier block corresponding to a distinct predetermined class of patterns and producing a mirror image of an input pattern if the input pattern belongs to the predetermined class. The system also comprises a plurality of sub-classifier blocks, each sub-classifier block corresponding to a distinct predetermined sub-class of a predetermined class of patterns and coupled to a classifier block corresponding thereto for producing a mirror image of an input pattern if the pattern belongs to the predetermined sub-class. The system further comprising an input unit for capturing the pattern for identification and an output unit for displaying at least one of a mirror image of an input pattern and an identified class and sub-class of the input pattern.

In an embodiment of the present invention, each of the classifier blocks and the sub-classifier blocks comprises a multilayered neural network having an input outermost layer and an output outermost layer wherein each layer comprising a plurality of adalines, the number of adalines decreasing proportionately from the input outer most layer to the inner most layer, the number of adalines increasing proportionately from the inner most layer to the output outer most layer. The inner most layer of adalines in the multilayered neural network outputs a reduced dimension image of the input pattern, the input pattern being re-constructible by using the image. The multilayered neural network is trained for outputting a mirror image of an input pattern by back propagation algorithm employing gradient descent to minimize a square of error between the input pattern and the output mirror image. In an embodiment of the present invention, the output pattern is a mirror image of the input pattern if a Euclidian distance between the normalized output pattern and the normalized input pattern is less than a predetermined threshold value.

In an embodiment of the present invention, the classifier blocks and the sub-classifier blocks are implemented as an embedded system comprising firmware.

A method for identifying a pattern as belonging to one of a set of predetermined classes of patterns is also provided. The method comprises the steps of: feeding an unidentified pattern to a set of classifier blocks, each classifier block corresponding to a distinct predetermined class of patterns and outputting a first mirror image of the unidentified pattern if the unidentified pattern belongs to the distinct predetermined class; determining if a mirror image of the unidentified pattern is output by at least one of the classifier blocks; identifying the class of patterns corresponding to a classifier block as the class of the unidentified pattern, if a mirror image of the unidentified pattern is output by the classifier block; feeding the output mirror image to all of the one or more of sub-classifier blocks corresponding to the identified class, each sub-classifier block corresponding to a predetermined sub-class and outputting a second mirror image of the unidentified pattern if the unidentified pattern belongs to the distinct predetermined sub-class; determining if a second mirror image of the unidentified pattern is output by at least one of the sub-classifier blocks; and identifying the sub-class of patterns corresponding to a sub-classifier block as the sub-class of the unidentified pattern, if a mirror image of the unidentified pattern is output by the sub-classifier block.

The present invention also provides a method for identifying a pattern belonging to one of a set of predetermined classes of patterns comprising the steps of: feeding an unidentified pattern to all of the one or more multilayered neural networks, each multilayered neural network having an input outermost layer and an output outermost layer wherein each layer comprising a plurality of adalines and outputting a mirror image of an input pattern if the input pattern belongs to a distinct predetermined class of patterns, the number of adalines decreasing proportionately from the input outer most layer to the inner most layer, the number of adalines increasing proportionately from the inner most layer to the output outer most layer; determining if a mirror image of the unidentified pattern is output by at least one of the multilayered neural network; identifying the class of patterns corresponding to a multilayered neural network as the class of the unidentified pattern, if a mirror image of the unidentified pattern is output by the multilayered neural network; obtaining a reduced dimension image of the unidentified pattern from the inner most layer of the multilayered neural network; determining an orientation vector of the reduced dimension image; and comparing the determined orientation vector with predetermined orientation vectors of one or more identified patterns corresponding to one or more sub-classes of the identified class to obtain a match.

In an embodiment of the present invention, the determined orientation vector of the unidentified pattern is compared with predetermined orientation vectors of one or more identified patterns by obtaining Euclidean distances between the determined orientation vector and each of the predetermined orientation vectors; and selecting the identified pattern corresponding to a least obtained Euclidian distance as a match for the unidentified pattern.

### BRIEF DESCRIPTION OF THE ACCOMPANYING DRAWINGS

The present invention is described by way of embodiments illustrated in the accompanying drawings wherein:

FIG. 1 illustrates a system for identification of patterns;

FIG. 2 illustrates an exemplary neural network designed to output a mirror image of an input pattern, if the input pattern belongs to a predetermined class; and

FIG. 3 illustrates a method for identification of patterns.

### DETAILED DESCRIPTION OF THE INVENTION

A system and method for identification of patterns is described herein. The present disclosure is more specifically directed towards identifying images. However, the system and method of the present invention may be used to identify any pattern from which comparable features may be extracted, as would be apparent to a person of ordinary skill in the art. For example, the present invention may be used in applications directed towards character recognition, speech recognition, medical diagnostic data analysis such as blood sample recognition, statistical patterns recognition, recognition of patterns in electrical signals, etc.

The following disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been omitted or have not been described in detail so as not to unnecessarily obscure the present invention.

The present invention would now be discussed in context of embodiments as illustrated in the accompanying drawings.

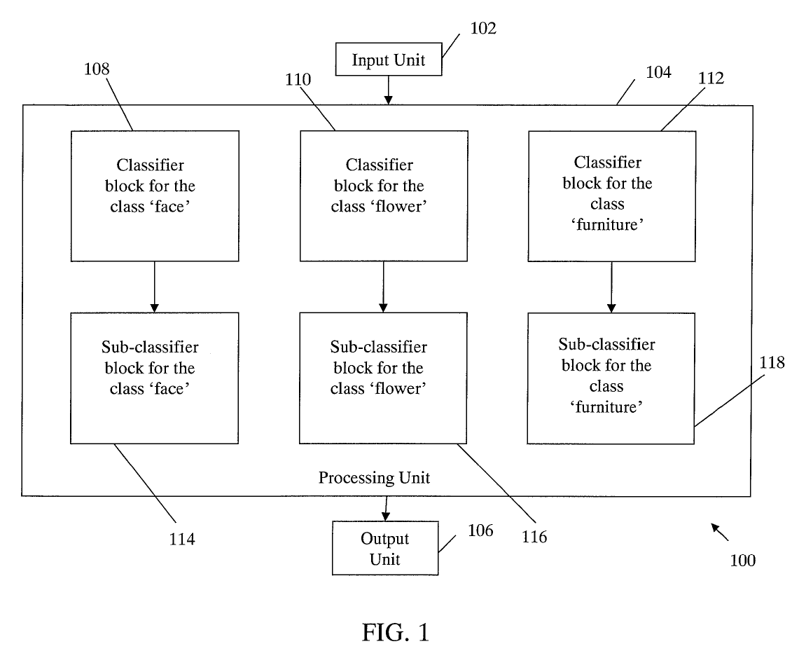

FIG. 1 illustrates a system for identification of patterns. System 100 comprises an input unit 102, a processing unit 104, and an output unit 106. Input unit 102 captures a pattern for identification. In an embodiment of the present invention, input unit 102 may be an image capturing device such as a camera, a scanner, or an MRI device. Input device 102 preferably captures images in a digital format. In embodiments of the present invention, where input device 102 captures images in an analog format, an analog to digital converter is used to convert the captured images into a digital format before said images are fed to processing unit 104.

Processing unit 104 comprises one or more of classifier blocks 108, 110 and 112 and one or more of sub-classifier blocks 114, 116 and 118. In an embodiment of the present invention, processing unit 104 is implemented as an embedded system comprising firmware.

Each of the classifier blocks 108, 110 and 112 comprises a neural network that is trained to output a mirror image of an input pattern, if the input pattern belongs to a predetermined class. For example, one of the classifier blocks 108 may comprise a neural network that is trained to output a mirror image of an input pattern, if the input pattern is a face, and another one of the classifier blocks 110 may comprise a neural network that is trained to output a mirror image of an input pattern, if the input pattern is a flower, whereas a third one of the classifier blocks 112 may comprise a neural network that is trained to output a mirror image of an input pattern, if the input pattern is a piece of furniture. In an embodiment of the present invention, if a mirror image of the input pattern is not output by any of the classifier blocks 108, 110 and 112, the input pattern is fed to a new classifier block. The new classifier block comprises

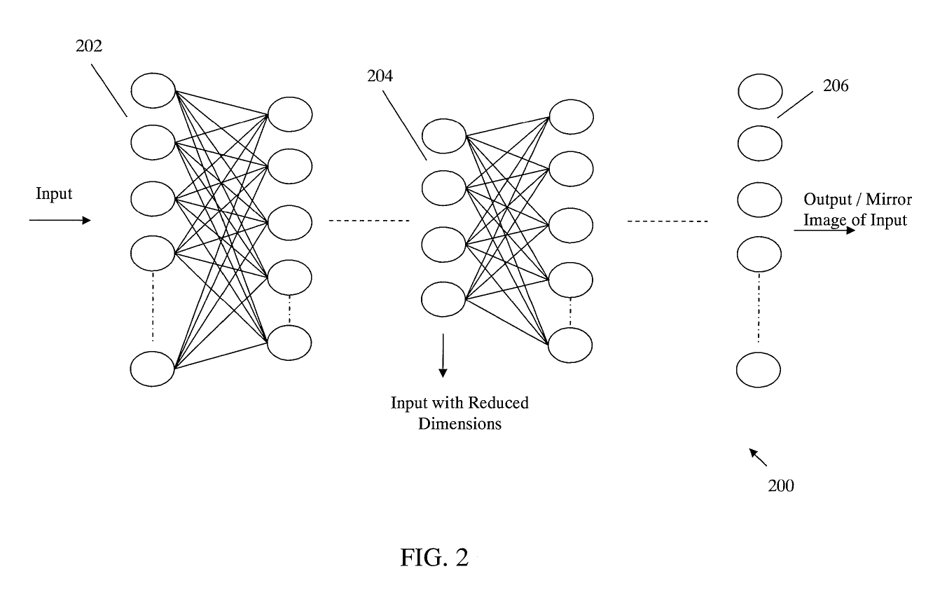

In an embodiment of the present invention, each of the classifier blocks 108, 110 and 112 comprises a multilayered neural network designed in a manner such that the neural network has a converging-diverging shape in which number of adalines in the outer layers is greater than number of adalines in the inner layers. FIG. 2 illustrates an exemplary neural network designed to output a mirror image of an input pattern, if the input pattern belongs to a predetermined class. The neural network comprises an input layer 202, an output layer 206 and a number of hidden layers.

In an embodiment of the present invention, if a mirror image of the input pattern is not output by any of the classifier blocks 108, 110 and 112, the input pattern is fed to a new classifier block. The new classifier block comprises a multilayered neural network designed in a manner such that the neural network has a converging-diverging shape in which number of adalines in the outer layers is greater than number of adalines in the inner layers. The multilayered neural network of the new classifier block undertakes unsupervised training and learns to identify the input pattern and produces a mirror image of the input pattern. This embodiment of the present invention aids in identifying new patterns and may be implemented to enable unsupervised self learning.

With reference to FIG. 2, the number of adalines in the layers of the neural network 200 gradually decreases from n adalines in the outermost input layer 202 (where n>4), to 4 adalines in an innermost layer 204 and then gradually increases to n adalines in the outermost output layer 206. In an exemplary embodiment of the present invention, the neural network comprises six layers with 25 adalines in the input layer, 5 adalines in a second subsequent layer, 6 adalines in a third subsequent layer, 3 adalines in a fourth subsequent layer, 8 adalines in a fifth subsequent layer and 25 adalines in a sixth subsequent layer, which layer is also an output layer.

The output of the innermost layer of the multilayered neural network 204, such as the neural network illustrated in FIG. 2, depicts the input pattern with reduced dimensions. For example, if the input layer 202 comprises 25 adalines, the input pattern fed to the layer is a 25 dimension pattern, which is reduced to a four dimension pattern being output by the innermost layer 204, since the fourth layer comprises four adalines. Neural network 200 is trained such that the inner most layer 204 outputs a pattern with reduced dimensions that comprises all properties of the original input pattern, such that the original input pattern may again be reconstructed from the pattern with reduced dimensions. In an embodiment of the present invention, back propagation technique, which is well known in the art, is used for training neural network 200 for producing a mirror image of an input pattern, if the input pattern belongs to a predetermined class. The back propagation technique employs a gradient descent method to minimize the square of error between the input pattern and the output pattern. In an embodiment of the present invention, a sigmoid function is used for obtaining accurate output patterns and, an output pattern is considered to be a mirror image of the input pattern if the Euclidian distance between the normalized output pattern and the normalized input pattern is less than a predetermined threshold value.

In the exemplary embodiment of the present invention where back propagation technique, is used for training neural network 200 for producing a mirror image of an input pattern, a gradient descent method is employed to minimize the square of error between an input pattern and an output pattern. For example, if there are n₁ adalines in the first layer 202 and inputs to the neural network 200 are depicted as X₁⁰, X₂⁰, . . . , Xₙ⁰, the output of the n₁ adalines maybe depicted as S₁¹, S₂¹, . . . , Sₙ_{₁}¹. A Sigmoid function defined as

Sgm(t)=tan h(t) (1)

is applied to the output of the n₁ adalines producing output depicted as X₁¹, X₂¹ . . . Xₙ¹, which in turn is input to a second layer of neural network 200 comprising n₂ adalines. The output of the second layer after passing through the Sigmoid function may be depicted as X₁², X₂², . . . , Xₙ². Similarly, the outputs of the adalines of the last or the lₜₕ layer of the neural network 200 maybe depicted as

Y₁=X₁¹,Y₂=X₂¹, . . . , Y_{nL}=Xₙₗ^{l} (2)

Hence, if a vector \vec{X}ₖ=X₁⁰, X₂⁰, . . . , Xₙ⁰ is input to the neural network 200, a final output Y₁, Y₂, . . . , Yᵣ is obtained, where r=n_{L}. If a desired output for the given input is d₁, d₂, . . . , dᵣ the sum of squares of error between the final output and the desired output may be denoted as

$${ɛ}^{2} = {\sum }_{k = 1}^{r} {( {d}_{k} - {Y}_{k} )}^{2} \qquad ( 3 )$$

The output of a jₜₕ adaline present in a lₜₕ layer of the neural network 200 may be denoted as

Sⱼ^{l}=[\vec{W}ⱼ^{l}]^{T}\vec{X}^{(l-1)} (4)

Where, \vec{W}ⱼ^{l} represents the weight of the jₜₕ adaline present in a lₜₕ layer. The weight may be adjusted in order to minimize the sum of squares of error ε² by using the following equation

\vec{W}ⱼ^{(l)(k+1)}=\vec{W}ⱼ^{(l)(k)}+λδⱼ^{l}\vec{X}^{(l-1)} (5)

where λ is a constant, \vec{W}ⱼ^{(l)(k)} represents the weight of the jₜₕ adaline present in the lₜₕ layer at a kₜₕ iteration and \vec{W}ⱼ^{(l)(k+1)} represents the weight of the jₜₕ adaline present in the lₜₕ layer at a (k+1)ₜₕ iteration. The values of δⱼ^{l} may be determined by using the following equations:

$${ɛ}_{j}^{l} = {\sum }_{n = 1}^{{n}_{l + 1}} {δ}_{n}^{l + 1} {\vec{W}}_{nj}^{( l + j )} \qquad ( 6 )$$

and

δⱼ^{l}=εⱼ^{l}S_{dgm′}(Sⱼ^{(l)})

where S_{dgm′}( ) represents derivative of the Sigmoid function. Hence, the neural network 200 may be trained to output a mirror image of an input pattern by iteratively reducing the error coefficient between the input pattern and an output pattern and correcting weights assigned to adalines based on the output pattern obtained after each iteration.

With reference to FIG. 1 sub-classifier blocks 114, 116 and 118 identify patterns belonging to a predetermined class. Each sub-classifier block is trained to identify a predetermined class of patterns which is a sub-class of at least one of the classes of patterns identified by the classifier blocks 108, 110 or 112. For example, sub-classifier blocks 114 may be trained to identify whether a pattern identified by classifier block 110 as a flower, is a rose or a tulip, etc. which are sub-classes of the class ‘flower’, whereas sub-classifier blocks 118 may be trained to identify whether a pattern identified by another classifier block 112 as a piece of furniture, is a table or a chair, etc. which are sub-classes of the class ‘furniture’.

In an embodiment of the present invention, each of the sub-classifier blocks 114, 116, 118 comprise a plurality of neural networks, each of which is trained to output a mirror image of an input pattern, if the input pattern belongs to a predetermined class of patterns which is a sub-class of at least one of the classes of patterns identified by the classifier blocks 108, 110, 112. For example, sub-classifier block 116 may comprise three neural networks; a first of the three neural networks being trained to output a mirror image of an input pattern, if the input pattern is a rose, a second of the three neural networks being trained to output a mirror image of an input pattern, if the input pattern is a tulip, and a third of the three neural networks being trained to output a mirror image of an input pattern, if the input pattern is a sunflower.

In an embodiment of the present invention, each of the sub-classifier blocks 114 to 118 comprises a plurality of multilayered neural networks designed in a manner such that each of the neural networks has a converging-diverging shape in which number of adalines in the outer layers is greater than number of adalines in the inner layers.

In various embodiments of the present invention, sub-classifier blocks 114-118 may implement various other pattern identification techniques for sub-classifying the patterns output by the classifier blocks 108, 110 and 112. In an embodiment of the present invention, a pattern input to the sub-classifier blocks 114, 116 and 118 may be sub-classified by determining orientation vectors. With reference to FIG. 2, the input pattern with reduced dimensions, obtained from the layer of neural network 200 which has a least number of adalines, serves as a feature vector for determining orientation vector of the input pattern. The feature vector and orientation vector may be stored in a memory module associated with the classifier blocks 108, 110 and 112. Since the input pattern with reduced dimensions and not the original input pattern is required to be stored, memory requirement is reduced.

The determined orientation vector may then be compared with orientation vectors corresponding to a plurality of identified patterns. The identified patterns and the corresponding orientation vectors may be stored in a memory module associated with the sub-classifier blocks 114, 116 and 118. For example, patterns corresponding to a tulip, a rose and a sunflower may be stored in a memory module corresponding to sub-classifier block 116. The comparison is carried out to obtain a least distance between the determined orientation vector corresponding to a reduced dimension version of the pattern output by classifier block 108, 110 and 112 and an orientation vector corresponding to any of the identified patterns. The identified pattern corresponding to the least distance is termed as a match. The pattern output by classifier block 108, 110 and 112 is identified as the match. In an embodiment of the present invention, a match is obtained by comparing Euclidean distances between the orientation vector corresponding to the pattern output by classifier block 108, 110 and 112 and each of the orientation vectors corresponding to the identified patterns.

Output unit 106 displays one or both of the input pattern and the pattern that the input pattern is identified as. In various embodiments of the present invention, output unit 106 may be any of the commonly available output devices such as a screen or a printer.

In an embodiment of the present invention, the system of the present invention may be implemented in an unmanned airplane monitoring a landscape. With reference to FIG. 1, pictures of the landscape may be captured by input unit 102 and fed to the processing unit 104. Instances of humans, animals and plants may be identified by the classifier blocks 108, 110 and 112, further identified as male or female, goat or cow, tree or shrub respectively by sub-classifier blocks 114, 116 and 118 and displayed via output unit 106 deployed at a monitoring station.

In an embodiment of the present invention the system 100 for identification of patterns illustrated in FIG. 1 is implemented on a single microprocessor chip. Each neural network corresponding to each of the classifier or sub-classifier blocks comprises one or more buffers to store the input pattern and the weights and a single floating-point arithmetic and logic unit (ALU) that performs a multiply-accumulate (MAC) operation. In an embodiment of the present invention, instead of providing as many ALUs as inputs and performing the MAC operations in parallel, the MAC operations may be pipelined to reduce the hardware overhead. The inputs may be stored in the one or more buffers and the MAC unit may perform one multiplication operation in one clock cycle and accumulate the results. Each bit of buffer storage requires six transistors. Hence, if it is assumed that there are eight inputs each comprising thirty two bits and, eight weights each comprising thirty two bits the buffers require approximately 3K transistors. A high performance thirty two bit floating-point ALU may be implemented by using approximately 230K transistors. If it is assumed that each mirroring neural network requires 250K transistors, the total overhead is less than 5M transistors, which is a small percentage of the total chip area.

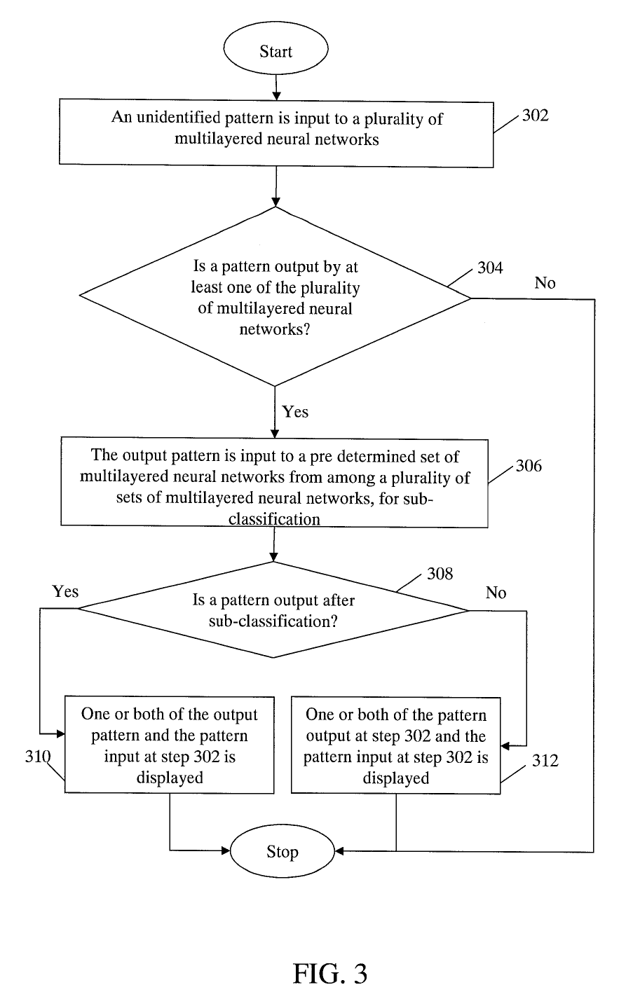

FIG. 3 illustrates a method for identification of patterns, in accordance with one embodiment of the present invention. At step 302, an unidentified pattern is input to a plurality of multilayered neural networks that are designed in a manner such that each neural network has a converging-diverging shape in which the number of adalines in the outer layers is greater than number of adalines in the inner layers. Each neural network is trained to output a mirror image of the input pattern, if the input pattern belongs to a predetermined class. In an embodiment of the present invention, the unidentified pattern is input to the plurality of multilayered neural networks simultaneously. In another embodiment of the present invention, the unidentified pattern is input to the plurality of multilayered neural networks serially, the unidentified pattern being input to a second multilayered neural network only if a predetermined output is not produced by a first multilayered neural network.

At step 304, it is determined whether a pattern is output by at least one of the plurality of multilayered neural networks. If a pattern is output by at least one of the plurality of multilayered neural networks, then at step 306, the output pattern is input to a predetermined set of multilayered neural networks from among a plurality of sets of multilayered neural networks, for sub-classification. In an embodiment of the present invention, if the pattern output at step 302 is a flower it is input to a first set of multilayered neural networks, where each multilayered neural networks is trained to output a mirror image of the input pattern, if the input pattern belongs to the class ‘flower’. One of the multilayered neural networks in the first set of multilayered neural networks may output a mirror image of the flower pattern if the flower pattern is a rose, while another one of the multilayered neural networks in the first set of multilayered neural networks may output a mirror image of the flower pattern if the flower pattern is a tulip and a third one of the multilayered neural networks in the first set of multilayered neural networks may output a mirror image of the flower pattern if the flower pattern is a sunflower.

In various embodiments of the present invention, various other pattern identification techniques may be employed for sub-classifying the pattern output at step 302. In an embodiment of the present invention, pattern output at step 302 may be sub-classified by determining orientation vectors. A reduced dimension version of the pattern input at step 302 is obtained from the inner most layer of the multilayered neural network that outputs a mirror image of the input pattern. The reduced dimension version of the input pattern serves as a feature vector for determining orientation vector of the input pattern.

The determined orientation vector may then be compared with orientation vectors corresponding to a predetermined set of identified patterns. For example, a set of identified patterns may comprise patterns corresponding to a tulip, a rose and a sunflower, whereas another set of identified patterns may comprise patterns corresponding to a table, a chair and a bedpost. The determined orientation vector corresponding to the input pattern is compared with orientation vectors corresponding to a predetermined set of identified patterns depending upon the class of the input pattern as determined at step 302. The comparison is carried out to obtain a least distance between the determined orientation vector corresponding to the input pattern and an orientation vector corresponding to any of the identified patterns. The identified pattern corresponding to the least distance is termed as a match. The pattern output at step 302 is identified as the match and the match is output at step 306. In an embodiment of the present invention, the determined orientation vector corresponding to the input pattern and orientation vectors corresponding to the identified patterns are compared by obtaining Euclidean distances between the determined orientation vector corresponding to the input pattern and each of the orientation vectors corresponding to the identified patterns.

At step 308, it is determined whether a pattern is output at step 306. If a pattern is output at step 306, one or both of the output pattern and the pattern input at step 302 is displayed to a user at step 310. If a pattern is not output at step 306, one or both of the pattern output at step 302 and the unidentified pattern input at step 302 is displayed to a user at step 312.

In an embodiment of the present invention, the method described with reference to FIG. 3 is used as a method of unsupervised learning for training a neural network. The trained neural network may be employed to automatically identify predetermined classes of patterns from any given set of patterns.

The system and methods of the present invention may be used in any application which provides for classification and identification of patterns. The system and method described in the present invention may also be used in any artificial intelligence or statistical based pattern recognition applications employing unsupervised training methods for ANNs. Further, the system of the present invention may be implemented as an embedded system comprising firmware corresponding to the classifier and the sub-classifier blocks.

The system and methods for identifying patterns as described are particularly well suited for applications involving identification of facial images, however, may be applied to other applications, as would be apparent to a person of skill in the art. For example, the system and methods of the present invention may be used in applications such as medical diagnostics, speech recognition, speaker recognition, machine diagnostics, and image classification, analysis and clustering.

While the exemplary embodiments of the present invention are described and illustrated herein, it will be appreciated that they are merely illustrative. It will be understood by those skilled in the art that various changes in form and detail may be made therein without departing from or offending the spirit and scope of the invention as defined by the appended claims.

We claim:

1. A system for identifying a pattern as belonging to one of a set of predetermined classes of patterns, the system comprising:
a plurality of classifier blocks, each classifier block corresponding to a distinct predetermined class of patterns and producing a mirror image of an input pattern if the input pattern belongs to the predetermined class; and
a plurality of sub-classifier blocks, each sub-classifier block corresponding to a distinct predetermined sub-class of a predetermined class of patterns and coupled to a classifier block corresponding thereto for producing a mirror image of an input pattern if the pattern belongs to the predetermined sub-class.

2. The system as claimed in claim 1 further comprising an input unit for capturing the pattern for identification.

3. The system as claimed in claim 1 further comprising an output unit for displaying at least one of a mirror image of an input pattern and an identified class and sub-class of the input pattern.

4. The system as claimed in claim 1 wherein each of the classifier blocks comprises a multilayered neural network having an input outermost layer and an output outermost layer wherein each layer comprising a plurality of adalines, the number of adalines decreasing proportionately from the input outer most layer to the inner most layer, the number of adalines increasing proportionately from the inner most layer to the output outer most layer.

5. The system as claimed in claim 4 wherein the inner most layer of adalines in the multilayered neural network outputs a reduced dimension image of the input pattern, the input pattern being re-constructible by using the image.

6. The system as claimed in claim 4 wherein the multilayered neural network is trained for outputting a mirror image of an input pattern by back propagation algorithm employing gradient descent to minimize a square of error between the input pattern and the output mirror image.

7. The system as claimed in claim 1 wherein each of the sub-classifier blocks comprises at least one multilayered neural network having an input outermost layer and an output outermost layer wherein each layer comprising a plurality of adalines, the number of adalines decreasing proportionately from the input outer most layer to the inner most layer, the number of adalines increasing proportionately from the inner most layer to the output outer most layer.

8. The system as claimed in claim 7 wherein the multilayered neural network is trained for outputting a mirror image of an input pattern by back propagation algorithm employing gradient descent to minimize a square of error between the input pattern and the output mirror image.

9. The system as claimed in claim 1 wherein the output pattern is a mirror image of the input pattern if a Euclidian distance between the normalized output pattern and the normalized input pattern is less than a predetermined threshold value.

10. The system as claimed in claim 1 wherein the classifier blocks and the sub-classifier blocks are implemented as an embedded system comprising firmware.

11. A method for identifying a pattern as belonging to one of a set of predetermined classes of patterns, the method comprising the steps of:
i. feeding an unidentified pattern to a set of classifier blocks, each classifier block corresponding to a distinct predetermined class of patterns and outputting a first mirror image of the unidentified pattern if the unidentified pattern belongs to the distinct predetermined class;
ii. determining if a mirror image of the unidentified pattern is output by at least one of the classifier blocks;
iii. identifying the class of patterns corresponding to a classifier block as the class of the unidentified pattern, if a mirror image of the unidentified pattern is output by the classifier block;
iv. feeding the output mirror image to all of the one or more of sub-classifier blocks corresponding to the identified class, each sub-classifier block corresponding to a predetermined sub-class and outputting a second mirror image of the unidentified pattern if the unidentified pattern belongs to the distinct predetermined sub-class; and
v. determining if a second mirror image of the unidentified pattern is output by at least one of the sub-classifier blocks; and
vi. identifying the sub-class of patterns corresponding to a sub-classifier block as the sub-class of the unidentified pattern, if a mirror image of the unidentified pattern is output by the sub-classifier block.

12. The method as claimed in claim 11 wherein each classifier block comprises a multilayered neural network having an input outermost layer and an output outermost layer wherein each layer comprising a plurality of adalines, the number of adalines decreasing proportionately from the input outer most layer to the inner most layer, the number of adalines increasing proportionately from the inner most layer to the output outer most layer.

13. The method as claimed in claim 11 wherein each of the sub-classifier blocks comprises at least one multilayered neural network having an input outermost layer and an output outermost layer wherein each layer comprising a plurality of adalines, the number of adalines decreasing proportionately from the input outer most layer to the inner most layer, the number of adalines increasing proportionately from the inner most layer to the output outer most layer.

14. The method as claimed in claim 11 wherein each of the multilayered neural networks is trained for outputting a mirror image of an input pattern by back propagation algorithm employing gradient descent to minimize a square of error between the input pattern and the output mirror image.

15. A method for identifying a pattern belonging to one of a set of predetermined classes of patterns, the method comprising the steps of:
i. feeding an unidentified pattern to all of the one or more multilayered neural networks, each multilayered neural network having an input outermost layer and an output outermost layer wherein each layer comprising a plurality of adalines and outputting a mirror image of an input pattern if the input pattern belongs to a distinct predetermined class of patterns, the number of adalines decreasing proportionately from the input outer most layer to the inner most layer, the number of adalines increasing proportionately from the inner most layer to the output outer most layer;
ii. determining if a mirror image of the unidentified pattern is output by at least one of the multilayered neural network;
iii. identifying the class of patterns corresponding to a multilayered neural network as the class of the unidentified pattern, if a mirror image of the unidentified pattern is output by the multilayered neural network;
iv. obtaining a reduced dimension image of the unidentified pattern from the inner most layer of the multilayered neural network;
v. determining an orientation vector of the reduced dimension image; and
vi. comparing the determined orientation vector with predetermined orientation vectors of one or more identified patterns corresponding to one or more sub-classes of the identified class to obtain a match.

16. The method as claimed in claim 15 wherein the determined orientation vector of the unidentified pattern is compared with predetermined orientation vectors of one or more identified patterns by:
i. obtaining Euclidean distances between the determined orientation vector and each of the predetermined orientation vectors; and
ii. selecting the identified pattern corresponding to a least obtained
Euclidian distance as a match for the unidentified pattern.

17. The method as claimed in claim 15 wherein each of the multilayered neural networks is trained for outputting a mirror image of an input pattern by back propagation algorithm employing gradient descent to minimize a square of error between the input pattern and the output mirror image.

18. An embedded system comprising firmware operable to perform all the steps of claim 11.

19. An embedded system comprising firmware operable to perform all the steps of claim 13.

20. A computer program product comprising a computer usable medium having a computer readable program code embodied therein for identifying a pattern as belonging to one of a set of predetermined classes of patterns, the computer program product comprising:
i. program instruction means for feeding an unidentified pattern to a set of classifier blocks, each classifier block corresponding to a distinct predetermined class of patterns and outputting a first mirror image of the unidentified pattern if the unidentified pattern belongs to the distinct predetermined class;
ii. program instruction means for determining if a mirror image of the unidentified pattern is output by at least one of the classifier blocks;
iii. program instruction means for identifying the class of patterns corresponding to a classifier block as the class of the unidentified pattern, if a mirror image of the unidentified pattern is output by the classifier block;
iv. program instruction means for feeding the output mirror image to all of the one or more of sub-classifier blocks corresponding to the identified class, each sub-classifier block corresponding to a predetermined sub-class and outputting a second mirror image of the unidentified pattern if the unidentified pattern belongs to the distinct predetermined sub-class; and
v. program instruction means for determining if a second mirror image of the unidentified pattern is output by at least one of the sub-classifier blocks; and
vi. program instruction means for identifying the sub-class of patterns corresponding to a sub-classifier block as the sub-class of the unidentified pattern, if a mirror image of the unidentified pattern is output by the sub-classifier block.

21. The computer program product as claimed in claim 20 wherein each classifier block comprises a multilayered neural network having an input outermost layer and an output outermost layer wherein each layer comprising a plurality of adalines, the number of adalines decreasing proportionately from the input outer most layer to the inner most layer, the number of adalines increasing proportionately from the inner most layer to the output outer most layer.

22. The computer program product as claimed in claim 20 wherein each of the sub-classifier blocks comprises at least one multilayered neural network having an input outermost layer and an output outermost layer wherein each layer comprising a plurality of adalines, the number of adalines decreasing proportionately from the input outer most layer to the inner most layer, the number of adalines increasing proportionately from the inner most layer to the output outer most layer.

23. A computer program product comprising a computer usable medium having a computer readable program code embodied therein for identifying a pattern belonging to one of a set of predetermined classes of patterns, the computer program product comprising:
i. program instruction means for feeding an unidentified pattern to all of the one or more multilayered neural networks, each multilayered neural network having an input outermost layer and an output outermost layer wherein each layer comprising a plurality of adalines and outputting a mirror image of an input pattern if the input pattern belongs to a distinct predetermined class of patterns, the number of adalines decreasing proportionately from the input outer most layer to the inner most layer, the number of adalines increasing proportionately from the inner most layer to the output outer most layer;
ii. program instruction means for determining if a mirror image of the unidentified pattern is output by at least one of the multilayered neural network;
iii. program instruction means for identifying the class of patterns corresponding to a multilayered neural network as the class of the unidentified pattern, if a mirror image of the unidentified pattern is output by the multilayered neural network;
iv. program instruction means for obtaining a reduced dimension image of the unidentified pattern from the inner most layer of the multilayered neural network;
v. program instruction means for determining an orientation vector of the reduced dimension image; and
vi. program instruction means for comparing the determined orientation vector with predetermined orientation vectors of one or more identified patterns corresponding to one or more sub-classes of the identified class to obtain a match.

24. The computer program product as claimed in claim 23 wherein the program instruction means for comparing the determined orientation vector of the unidentified pattern with predetermined orientation vectors of one or more identified patterns comprise:
i. program instruction means for obtaining Euclidean distances between the determined orientation vector and each of the predetermined orientation vectors; and
ii. program instruction means for selecting the identified pattern corresponding to a least obtained Euclidian distance as a match for the unidentified pattern.
